(19) United States
(12) Patent Application Publication
(10) Pub. No.: US 2019/0005574 A1
(43) Pub. Date: Jan. 3, 2019

(54) SYSTEM AND METHOD FOR MATCHING A SERVICE PROVIDER TO A SERVICE REQUESTOR

(71) Applicant: Odvest 157 (Pty) Ltd, Cape Town (ZA)

(72) Inventors: Johann Mouton OLIVIER, Gauteng (ZA); Francois Christiaan COETZER, Cape Town (ZA); Hennie Rood VAN WYK, Cape Town (ZA)

(73) Assignee: Odvest 157 (Pty) Ltd, Cape Town (ZA)

(21) Appl. No.: 15/702,487

(22) Filed: Sep. 12, 2017

(30) Foreign Application Priority Data
Jun. 28, 2017 (ZA) 2017/04375

(51) Int. Cl. G06Q 30/06; G06F 17/30

(52) U.S. Cl. CPC G06Q 30/0645; G06F 17/30864

(57) ABSTRACT

A system and method for matching a service provider to a service requestor are provided. In a method, a set of attributes relating to a requested service are received from a service requestor via a service requestor portal. A plurality of points corresponding to geographical coordinates are received from the service requestor via the service requestor portal. The points define a geographical polygon in which the requested service is to be provided. The attributes and points are stored in association with a requested service record. The attributes and points are used to query a service provider database to identify a service provision record being associated with substantially corresponding attributes and with geographical location data corresponding with the geographical polygon defined by the points. An identified service provision record is associated with the requested service record. A notification of the association is transmitted to the service provider and/or service requestor.

### PRIORITY CLAIM

This application claims the benefit of South African application number 2017/04375 filed Jun. 28, 2017, the contents of which are incorporated by reference.

### FIELD OF THE INVENTION

This invention relates to a system and method for matching a service provider to a service requestor. In particular, the invention relates to a system and method for matching a service provider providing property for lease to a service requestor seeking to lease property.

### BACKGROUND OF THE INVENTION

Online services for leasing property are becoming increasingly popular. Such services may exist for residential, retail and commercial properties. In a typical online service, a user may input certain attributes associated with the type of property to be leased and may receive results of available properties having matching attributes. One of these attributes may be the geographical location of the property, which is typically broadly defined by way of a suburb, zip or postal code or the like.

In certain cases, for example in the leasing of retail property, a high degree of specificity may be required as the property to be leased, its location and/or attributes may need to be suitable in relation to the types of goods or services to be sold or provided from the property to be rented.

In location-based matching, problems may arise where different users use different strings (e.g. “1 Orange Road, Cape Town” versus “1 Orange Street, Rondebosch, Cape Town”) or street names which span multiple suburbs to describe the location of the same property. This may increase the complexity of searching algorithms that are required to identify available properties based on a location string and may also lead to an undesirable number of false negatives.

Further, the degree of specificity in matching the needs of the entity searching for property to be leased to the offerings of entities providing properties to be leased may be insufficient. This may lead to wasted time on the side of both the potential lessee and the potential lessor.

Accordingly, there is scope for improvement.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY OF THE INVENTION

In accordance with an aspect of the invention there is provided a computer-implemented method for matching a service provider to a service requestor comprising:
receiving, from a service requestor via a service requestor portal, a set of attributes relating to a requested service;
receiving, from the service requestor via the service requestor portal, a plurality of points corresponding to geographical coordinates, the points defining a geographical polygon in which the requested service is to be provided;
storing the attributes and points in association with a requested service record;
using the attributes and points to query a service provider database to identify a service provision record being associated with attributes which substantially correspond to the attributes associated with the requested service record and being associated with geographical location data corresponding with the geographical polygon defined by the points;
associating an identified service provision record with the requested service record; and,
transmitting a notification of the association to one or both of the service provider and service requestor.

A further feature provides for the method to include: receiving, from the service provider via a service provider portal, the geographical location data and attributes; associating the received geographical location data and attributes with the service provision record.

A still further feature provides for the method to include continually querying the service provider database on a periodic basis so as to identify any new service provision records having matching attributes and geographical location data.

A yet further feature provides for the method to include using the attributes and the geographical location data associated with the service provision record to query a service requestor database to identify requested service records being associated with attributes which substantially correspond to those of the service provision record and points which define a geographical location with which the geographical location data corresponds.

An even further feature provides for the identity of the service provider to be withheld from the service requestor until association of the identified service provision record with the requested service record and for the identity of the service requestor to be withheld from the service provider until the service requestor initiates contact with the service provider in response to the association of the identified service provision record with the requested service record.

A further feature provides for the method to include: receiving allocation/deallocation instructions from the service provider via the service provider portal; rendering property overlays to indicate an allocation/deallocation status based on the allocation/deallocation instructions received; and providing, to one or both of the service provider and service requestor via the service provider and service requestor portals respectively, the rendered property overlays indicating the allocation/deallocation status for display on a map provided by a mapping service.

A still further feature provides for the method to include: receiving, from a service requestor via a service requestor portal, a forward instruction requesting forwarding of a notification of association of a service provision record with a requested service record; and, generating and transmitting a forward notification to an identified communication address.

In accordance with a further aspect of the invention there is provided a system for matching a service provider to a service requestor, the system including a memory for storing computer-readable program code and a processor for executing the computer-readable program code, the system comprising:
a requested service attribute receiving component for receiving, from a service requestor via a service requestor portal, a set of attributes relating to a requested service;
a geographical point receiving component for receiving, from the service requestor via the service requestor portal, a plurality of points corresponding to geographical coordinates, the points defining a geographical polygon in which the requested service is to be provided;
a storing component for storing the attributes and points in association with a requested service record;
a querying component for using the attributes and points to query a service provider database to identify a service provision record being associated with attributes which substantially correspond to the attributes associated with the requested service record and being associated with geographical location data corresponding to the geographical polygon defined by the points;
an associating component for associating an identified service provision record with the requested service record; and,
a notification transmitting component for transmitting a notification of the association to one or both of the service provider and service requestor.

A further feature provides for the system to include: a service provider data receiving component for receiving, from the service provider via a service provider portal, the geographical location data and attributes; and for the associating component to associate the received geographical location data and attributes with the service provision record.

A still further feature provides for the querying component to continually querying the service provider database on a periodic basis so as to identify any new service provision records having corresponding attributes and geographical location data.

A yet further feature provides for the querying component use the attributes and the geographical location data associated with the service provision record to query a service requestor database to identify requested service records being associated with attributes which substantially correspond to those of the service provision record and points which define a geographical location with which the geographical location data corresponds.

An even further feature provides for the identity of the service provider to be withheld from the service requestor until association of the identified service provision record with the requested service record and for the identity of the service requestor to be withheld from the service provider until the service requestor initiates contact with the service provider in response to the association of the identified service provision record with the requested service record.

A further feature provides for the system to include: an allocation/deallocation instruction receiving component for receiving allocation/deallocation instructions from the service provider via the service provider portal; a rendering component for rendering property overlays to indicate an allocation/deallocation status based on the allocation/deallocation instructions received; and a providing component for providing, to one or both of the service provider and service requestor via the service provider and service requestor portals respectively, the rendered property overlays indicating the allocation/deallocation status for display on a map provided by a mapping service.

A still further feature provides for the system to include: a forward instruction receiving component for receiving, from a service requestor via a service requestor portal, a forward instruction requesting forwarding of a notification of association of a service provision record with a requested service record; and, a forward notification generating and transmitting component generating and transmitting a forward notification to an identified communication address.

In accordance with a further aspect of the invention there is provided a computer program product for matching a service provider to a service requestor, the computer program product comprising a computer-readable medium having stored computer-readable program code for performing the steps of:
receiving, from a service requestor via a service requestor portal, a set of attributes relating to a requested service;
receiving, from the service requestor via the service requestor portal, a plurality of points corresponding to geographical coordinates, the points defining a geographical polygon in which the requested service is to be provided;
storing the attributes and points in association with a requested service record;
using the attributes and points to query a service provider database to identify a service provision record being associated with attributes which substantially correspond to the attributes associated with the requested service record and being associated with geographical location data corresponding with the geographical polygon defined by the points;
associating an identified service provision record with the requested service record; and,
transmitting a notification of the association to one or both of the service provider and service requestor.

Further features provide for the computer-readable medium to be a non-transitory computer-readable medium and for the computer-readable program code to be executable by a processing circuit.

Embodiments of the invention will now be described, by way of example only, with reference to the accompanying drawings.

### BRIEF DESCRIPTION OF THE DRAWINGS

In the drawings:

FIG. 1 is a schematic diagram which illustrates an exemplary system for matching a service provider to a service requestor;

FIG. 2 is a swim-lane flow diagram which illustrates an exemplary method for matching a service provider to a service requestor;

FIG. 3 is a block diagram which illustrates components of an exemplary system for matching a service provider to a service requestor;

FIG. 4 illustrates an exemplary service provider portal by way of which attributes associated with a service provision record may be input;

FIG. 5 illustrates an exemplary service requestor portal by way of which attributes associated with a requested service record may be input;

FIG. 6 illustrates a map provided by a mapping service on which is displayed a plurality of configurable points which define a geographical polygon, the area of which is adjustable by adjusting the position of the points on the map, and which defines an area in which a requested service is to be provided;

FIG. 7 illustrates an exemplary service requestor portal by way of which geographical points defining a number of geographical polygons are input and transmitted to a matching entity;

FIG. 8 illustrates an exemplary scenario in which a geographical polygon spans multiple streets and multiple suburbs;

FIG. 9 illustrates geographical radii which delineate deallocation of any new sites within an existing trade restriction area; and

FIG. 10 illustrates an example of a computing device in which various aspects of the disclosure may be implemented.

### DETAILED DESCRIPTION OF THE PREFERRED EMBODIMENT

Aspects of this disclosure are directed towards the matching of service providers to service requestors in a manner that caters with a high degree of specificity to the needs of the service providers and service requestors respectively.

While this disclosure is described primarily with reference to a retail property leasing scenario, the term “service” as used herein should be construed broadly to include any activity of contributing to the fulfilment of a need or furtherance of an effort or purpose performed by one for the benefit of another. In particular, the term should be construed to include: the letting of property by a lessor (a service provider) to a lessee (a service requestor); the selling of property by a seller (a service provider) to a buyer (a service requestor); and the like. A service provider may be a person or entity who provides the service in question while the service requestor may be a person or entity who requires or desires provision of the service.

In some example implementations, aspects of the disclosure are provided towards matching lessors to lessees based on the property attributes and location required by the lessees and attributes and locations of available properties of the lessors. The high degree of specificity may include the precise delineation of geographical boundaries within which the lessee requires to lease property, in some implementations including within a floorplan of a shopping mall or the like.

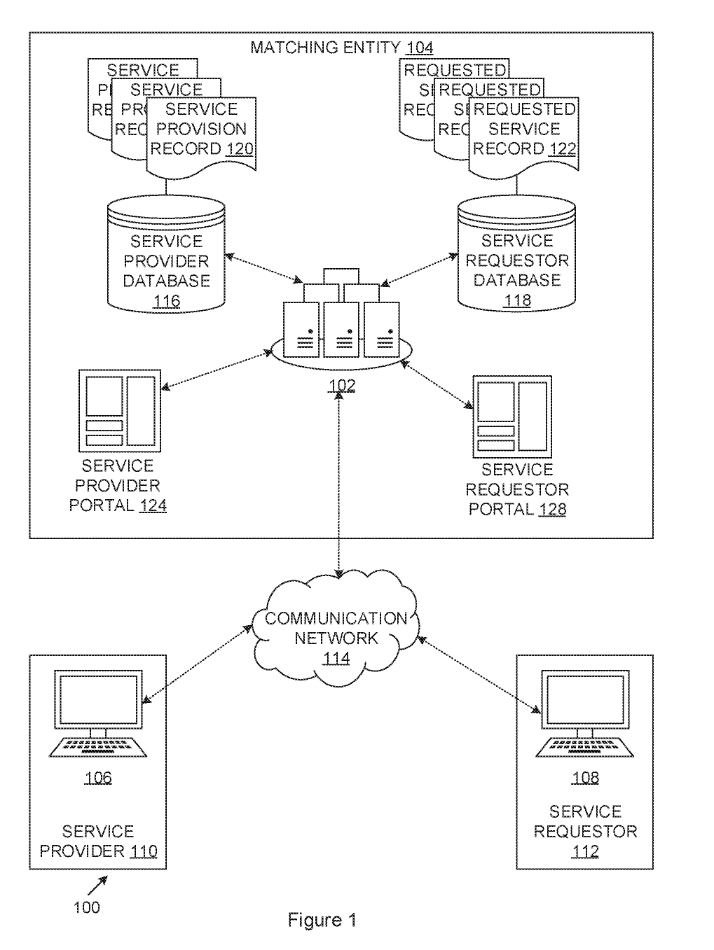

FIG. 1 is a schematic diagram which illustrates an exemplary system (100) for matching a service provider to a service requestor. The system (100) may include a server computer (102) maintained by a matching entity (104) and computing devices (106, 108) maintained by a service provider (110) and service requestor (112), respectively. The server computer (102) and computing devices (106, 108) may be configured to communicate with each other via a suitable communication network (114), such as the Internet. Although only one service provider (110) and one service requestor (112) are illustrated, it should be appreciated that in a practical implementation there may be a plurality of each of these.

The server computer (102) may be any appropriate computing device performing a server role and may have access to a number of databases, including a service provider database (116) and a service requestor database (118). Service provision records (120) may be stored in the service provider database (116) and requested service records (122) may be stored in the service requestor database (118). Each service provision record may be associated with a service provider while each requested service record may be associated with a service requestor.

As will be explained in greater detail below, the server computer (102) may be configured to match requested service records to service provision records. Matching may be dynamic, for example, the server computer (102) may dynamically query the service provider database (116) for records matching those in the service requestor database (118) and vice versa. Matching of records may be within configurable thresholds. For example, matching may not be exact, but based on best fit. Weighting may also be applied to weigh some attributes more heavily than others. As such, the server computer may be configured to identify service provision records which “substantially correspond” to a requested service record and vice versa.

The computing devices (106, 108) may be any appropriate computing devices and may be configured to interact with the server computer via service requestor and service provider portals (124, 128) respectively.

In some cases, the portals (124, 128) may be provided by websites hosted by the server computer (102) and accessible to the computing devices by way of appropriate web browsers. In other cases, the portals (124, 128) may be provided by custom software applications executing on the computing devices (e.g. a mobile software application downloadable from an application repository). In general, the portals may be any suitable web, desktop or mobile system that can execute machine language to provide the described functionality.

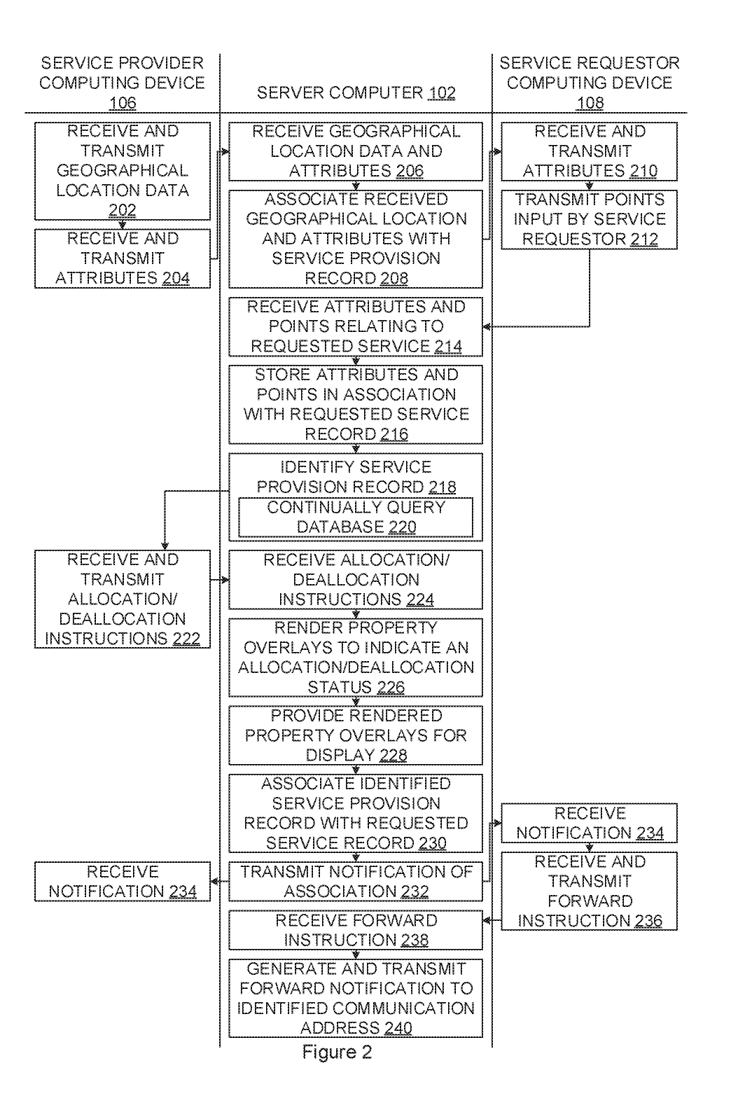

The system (100) described above may implement a method for matching a service provider to a service requestor. FIG. 2 is a swim-lane flow diagram which illustrates an exemplary method for matching a service provider to a service requestor in which respective swim-lanes delineate functions, operations, steps, etc. performed by respective entities. The method of FIG. 2 is described with reference to an exemplary implementation in which the service provider is a retail property lessor and the service requestor is a lessee seeking to lease retail property. The term “property” as used herein should be broadly construed to include a building, house, flat, apartment, shop space or indeed any space or zone suitable for occupation by a lessee.

If the service provider (110) is using the system for the first time, the service provider (110) may be required to create a service provider profile using the service provider portal (124). The service provider profile may be stored in the service provider database (116) and may be linked to each service provision record (120) associated with the service provider (110).

The service provider (110) may use the service provider portal (124) to create a service provision record (120). In some implementations, creating the service provision record (120) may include creating a building profile record. The building profile record may be associated with a physical building and in some cases corresponding floorplans, each being associated with a floor level and delineating a plurality of properties (e.g. shop spaces) within the building (at least some of which may be under the service provider's control and available for leasing). Creating the building profile record may include associating the building profile record with geographical location data of the physical building to which the record relates. The geographical location data may include a floorplan of the building which may be associated with a floor level, mapped to geographical coordinates and configured for overlaying onto a map provided by a mapping service. In other cases, the building profile record may have already been created or may not be required.

In some implementations, creating a service provision record may create a “property listing”, where a property within a building is associated with attributes and listed as being available. Creating the service provision record (120) may include the service provider inputting geographical location data for association with the service provision record (120). This may include the server computer (102) linking the service provision record with a building profile record, and hence linking the service provision record (120) to a geographical location (being that of the building). The geographical location data may be in the form of a geographical location point or a collection of points (e.g. defining a polygon or other shape). In some implementations, the geographical location data may be in the form of a floorplan polygon which defines the floor plan of the property (e.g. the floorplan of the shop). In some cases, this polygon may be used to calculate the size of the property and to deduce other useful data. The polygon associated with the property may be linked to a polygon associated with a floorplan of a building in which the property (or shop) is located. Thus, the geographical location data of the service provision record may be input in the form of user selection of a building profile record to be associated with the service provision record being created and in some cases, may include the designation of a particular zone (e.g. shop) within the building of the selected building profile record. This may include selection of a single geographical coordinate or a geographical polygon associated with the property. The computing device (106) may receive and transmit (202) the geographical location data input by the service provider (110) to the server computer (102) for association with the service provision record (120). Transmission of the geographical location data from the computing device (106) to the server computer (102) may be via the communication network (114).

Creating the service provision record (120) may include the service provider (110) inputting one or more attributes relating to the service provision record (120) into the computing device (106). In this exemplary retail property scenario, the attributes may include one or more of the group of: an identification of the retail property (e.g. shop number); a description of the retail property; the address of the retail property; the extent of the retail property (e.g. square meterage); the date from which the retail property will be available; the retail property category (e.g. a preferred trading category such as “audio visual”, “banks”, “baby shops”, “fashion”, etc.); one or more photographs of the retail property; a floorplan of the retail property; a target living standards measure (LSM) associated with the retail property; and the like. In the case of the provision of other services, the attributes may generally specify the details of the service that is to be provided.

The computing device (106) may receive and transmit (204) the attributes input by the service provider (110) to the server computer (102). Transmission of the attributes from the computing device (106) to the server computer (102) may be via the communication network (114).

The server computer (102) may receive (206) the geographical location data and attributes from the computing device (106). The attributes and geographical location data may be received separately or together and may be received via the service provider portal (124). FIG. 4 illustrates an exemplary service provider portal by way of which attributes associated with a service provision record may be input.

The server computer (102) may associate (208) the received geographical location data and attributes with the service provision record (120). In some implementations, this may include associating a building profile record with the service provision record (120). The server computer (102) may also associate the service provision record (120) with the profile of the service provider (110). The geographical location data may be stored with a high degree of precision (e.g. as described below in relation to the data points) for precise matching of geographical location data and points.

If the service requestor (112) is using the system for the first time, the service requestor (112) may be required to create a service requestor profile using the service requestor portal (128). The service requestor profile may be stored in the service requestor database (118) and may be linked to each requested service provision record (120) associated with the service provider (110).

The service requestor (112) may use the service requestor portal (128) to create a requested service record (122). Creating the requested service record (122) may include creating a trade profile record associated with the service requestor (112).

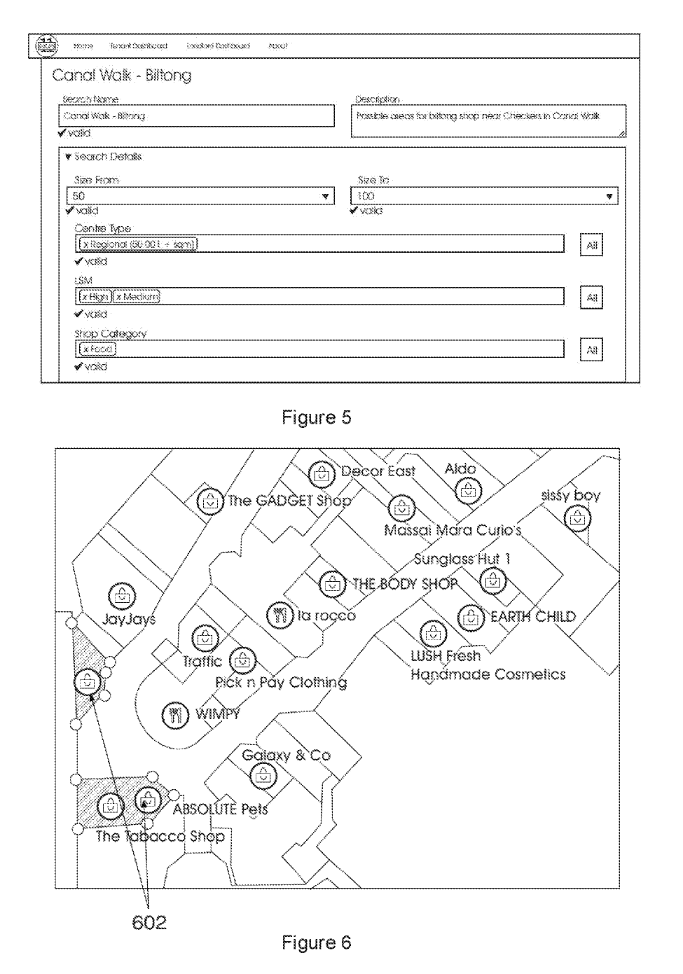

In some implementations, creating a requested service record (122) may create a requested service record (122) in the form of a saved search. Creating the requested service record (122) may include the service requestor (112) inputting one or more attributes relating to the requested service record (122) into the computing device (108). In this exemplary retail property scenario, the attributes may include one or more of the group of: an identification of the requested service record (e.g. a name of the saved search); a description of the requested service record; the extent of the retail property sought (e.g. square meterage, in some cases in a range); the type of retail property sought (e.g. nature and/or size of the building, such as community, regional, national shopping mall, etc.); the retail property category; a LSM associated with the retail property sought; and the like. In some implementations, the service requestor may be limited to selecting one or two retail property categories only. This may mean that a service requestor may be limited to searching for categories that are applicable to the service requestor only. In some implementations, the system may be configured to detect and disrupt attempts to search most or all of the categories (e.g. multiple searches, each with two different categories). In the case of the provision of other services, the attributes may generally specify the details of the service that is sought by the service requestor. The computing device (108) may receive and transmit (210) the attributes input by the service requestor (112) to the server computer (102) for association with the requested service record (122). Transmission of the attributes from the computing device (108) to the server computer (102) may be via the communication network (114). FIG. 5 illustrates an exemplary service requestor portal by way of which attributes associated with a requested service record may be input.

Creating the service provision record (120) may include the service requestor inputting a geographical location for association with the requested service record (122). This may include the server computer (102) causing the service requestor portal (128) to display a map, for example by embedding a map provided by an external mapping service (e.g. Google™ Maps™) or using a map provided by the service provider or another entity (e.g. the matching entity), and providing a geographical point input component configured for receiving selection of a plurality of points corresponding to geographical coordinates on the map. The geographical point input component may provide a plurality of user-configurable points which define a geographical polygon. The points may be associated with an order which may be used subsequently to recreate the geographical polygon. A geographical polygon as used herein may include a set of three or more points corresponding to geographical coordinates that are connected by lines in a specific order. The last and first coordinates must also be connected. The order may be important because if the points are not connected in a specific order the polygon cannot easily be reconstructed. Adjustment of the points on the map by the service requestor adjusts the geographical polygon and the geographical area defined within the polygon. In this manner the service requestor may adjust the positioning of the points displayed on the map of the service requestor portal (128) so as to adjust the shape and size of the geographical polygon and in turn the geographical area falling within the area defined by the geographical polygon. In some cases, the map may include floorplans of one or more buildings with an option to move between floors of the building, and each floorplan may include a delineation of properties within the associated building. Exemplary geographical polygons (602) defined by a plurality of points and displayed on a mapping service map are illustrated in FIG. 6.

Once the service requestor is satisfied with the area defined by the geographical polygon, the service requestor may save or finalise the geographical polygon. Having received the points by way of the service provider's adjustment, the computing device (108) may in turn transmit (212) the points to the server computer (102). Transmission of the points may be via the communication network (114).

The server computer (102) may receive (214) the set of attributes and plurality of points relating to the requested service from the service requestor (112) via the service requestor portal (128). The plurality of points may correspond to geographical coordinates and define a geographical polygon in which the requested service is to be provided (e.g. a retail property is to be leased).

The server computer (102) may store (216) the attributes and points in association with the requested service record (122). The points may be stored in association with an order for subsequent recreation of the geographical polygon. By storing the points (corresponding to geographical coordinates) as well as the order in which the points must be connected, the geographical polygon may be efficiently stored in the database and reconstructed at a later stage. In some cases, the points may be associated with a floor level indicator for searching multi-story buildings and/or an altitude indicator for three-dimensional location specification. This may enable searches in three-dimensional space with a high degree of specificity.

The points may be stored with a high degree of precision. For example, each point may be stored as a datatype of decimal (20,15) for each of the latitude and longitude, where 20 indicates the precision and 15 the scale (e.g. meaning 15 to right of decimal and 5 to the left). Storing the points (and other geographical location) with a high degree of precision (e.g. by virtue of including 15 decimal places) may prevent unintentional shifting of a reconstructed polygon (which could lead to non-deterministic results). In other implementations, other values for precision and scale may be used (e.g. a precision of 20 and a scale of 17 and the like).

The server computer (102) may use the attributes and points to query the service provider database (116) to identify (218) a service provision record (120) being associated with attributes which substantially correspond to the attributes associated with the requested service record (122) and being associated with geographical location data corresponding with the geographical polygon defined by the points.

In some implementations, geographical matching is performed initially to obtain a subset of service provision records being associated with geographical location data corresponding with the geographical polygon defined by the points. Service provision records of this subset having attributes which substantially correspond to the attributes associated with the requested service record may then be identified. Due to the high degree of specificity of the geographical location data associated with the records described herein, initially identifying records with matching or overlapping geographical location data and then considering the attributes may improve the efficiency and speed of the search algorithm (e.g. because typically there will be fewer records with matching/overlapping geographical location data than there will be with matching attributes).

Identifying (218) geographical location data corresponding to the geographical polygon may include finding geographical data defining a polygon which falls within or overlaps the geographical polygon defined by the points. For example, the geographical polygon defined by the points may match or overlap multiple polygons and/or point coordinates.

In some implementations, floorplans (being associated with a floor level) could be provided. Each property on the overlaid floorplan (which may also be implemented as a polygon) may be marked with a coordinate point (or another small polygon following the borders of the property on the floorplan). For example, in one exemplary scenario, the service requestor may wish to search for a specific section inside a building and can use the service requestor portal to create a geographical polygon (or multiple polygons) inside a floorplan of a building to search only a specific area (or multiple areas) of a floor (or multiple floors) within a building. In this example, multiple geographical polygons may interact with each other. For example: a floorplan polygon or many overlapping floorplans indicating a multiple floor building; geographical coordinate points associated with each property within the building or polygons tracing the borders of each property per floor; and, one or more service requestor geographical polygon defining a geographical area to search. The geographical polygons described herein may have a large geographical area drawn, e.g., over a town, city or suburb, or may have a small geographical area drawn over a small section of a floor in a building.

The server computer (102) may use an algorithm to search for and return as primary matches all property polygons or geographical points falling within the geographical polygon defined by the service requestor search. The server computer (102) may return as secondary matches all property polygons overlapping (but not falling within) the geographical polygon defined by the service requestor search (i.e. border results). Tertiary matches falling a certain distance outside the geographical polygon defined by the service requestor search may also be identified and returned. In some implementations, the algorithm may use negative search data to specifically exclude service provision records falling within excluded geographical locations.

In some implementations, identifying (218) geographical location data corresponding to the geographical polygon may include the server computer (102) accessing the plurality of points from the service requestor database (118) and reconstructing the geographical polygons. Reconstruction of polygons using points and an order may be performed by an appropriate geographic information system (GIS). A geolocation library may then be used to match all coordinates stored in the service requestor database (118) that fall within the reconstructed polygon. In some implementations, matching the points may be preceded by matching the attributes to improve efficiency.

In some cases, the server computer (102) may compare a floor level associated with the points to a floor level associated with the geographical location data.

Some or all of the attributes may be associated with a corresponding predetermined threshold match and identifying service provision records (120) may include comparing each attribute type of the service provision record (120) and the requested service record (122) to identify those attribute types having values which match within the corresponding predetermined threshold.

The server computer (102) may continually (220) query the service provider database (116) on a periodic basis such that any new service provision records having matching attributes and geographical location data may be identified. Similarly, in some implementations, the server computer (102) may use attributes and the geographical location data associated with the service provision record (120) to query the service requestor database (118) to identify requested service records (122) with attributes which substantially correspond to those of the service provision record (120).

The service provider (110) may use the service provider portal (124) to interactively allocate and deallocate the availability of properties. The server computer (102) may display a map to the service provider (110) via the service provider portal (124) and overlay on the map properties associated with service provision records linked to the service provider profile. In some implementations, the server computer (102) may overlay floorplans of buildings associated with building profile records linked to the service provision record (120). The property overlays may be in the form of shaded regions displayed on the map at geographical locations corresponding those of the associated physical buildings and may be configured to receive an “allocation” or “deallocation” input from the service provider (110) via the service provider portal (124). An “allocation” instruction may allocate the relevant property as being available (i.e. indicate that the property is available), while a “deallocation” instruction may deallocate the relevant property as being available (i.e. indicate that the property is no longer available).

The service provider may input allocation/deallocation instructions into the service provider portal (124). The computing device (106) may receive and transmit (222) the allocation/deallocation instructions, each instruction being associated with a service provision record, to the server computer (102).

The server computer (102) may receive (224) the allocation/deallocation instructions from the computing device via the service provider portal (124). The server computer (102) may render (226) the property overlays to indicate an allocation/deallocation status based on the allocation/deallocation instructions received and provide (228) the rendered property overlays indicating the allocation/deallocation status for display on the map to the service via the service provider portal (124).

The interactive allocation/deallocation functionality described above may enable a service provider having multiple service provision records (e.g. multiple properties to lease to potential service requestors) to select which of the service provision records is recognized by the server computer as being available. Only allocated service provision records may be identified in the above identifying step.

It should be appreciated that up until this point, the service requestor does not know that the service provider is offering a property for lease and the service provider does not know that the service requestor is looking for a property to lease. Thus, the initial steps of creating service provision and requested service records are completely anonymous. Given the high degree of specificity, it may be some time before a match is identified and for the whole of this time period, each party's actions will be completely confidential.

Once a service provision record (120) which substantially corresponds to the requested service record (122) is identified (in some cases this may only be after such a service provision record has been created or has been allocated), the server computer (102) may associate (230) the identified service provision record (120) with the requested service record (122) and transmit (232) a notification of the association to one or both of the service provider (110) and service requestor (112). The association may indicate that the service provision record (120) and requested service record (122) (or associated attributes and geographical data) substantially correspond.

The notifications may be received (234) at either or both of the computing devices (106, 108) of the service provider and service requestor respectively. In some implementations, the notifications may be configured for anonymity, e.g. by withholding the identities of the service provider and service requestor respectively. For example, the notification at the service provider may simply indicate the attributes desired by the service requestor and which of the service provider's service provision records match the associated requested service record. Similarly, the notification at the service requestor may simply indicate the attributes of the associated service provision record. The service provider's identity may be withheld from the service requestor and vice versa. In some implementations, the notifications may only indicate that a match has been identified, and may not disclose any attributes relating to the service provision record or requested service record. In some implementations, the identity of the service provider may be withheld from the service requestor until association of the identified service provision record with the requested service record while the identity of the service requestor may be withheld from the service provider until the service requestor initiates contact with the service provider. The service requestor may be required to be registered and logged-in before being able to access the identity (and possibly contact details) of the service provider. In other implementations, the notifications may disclose the identity of the service provider and service requestor.

In some cases the service provision request may be created by one entity on behalf of another (e.g. by an agent seeking available properties for a client). The service requestor portal (128) may accordingly enable forwarding of matching service provision records to non-subscribed users. The computing device (108) of the service requestor may receive and transmit (236) a forward instruction in respect of a notification of association of a service provision record with a requested service record to the server computer (102).

The server computer (102) may receive (238) the forward instruction, which may include an associated destination communication address (e.g. email address or phone number), from the computing device (108) and generate and transmit (240) a forward notification to an identified communication address. The forward notification may include or provide a link enabling the relevant entity to access one or both of: attributes of the identified service provision record; and, attributes of the requested service record. In some implementations, the forward notification may be configured to withhold the attributes from the relevant entity until the entity has registered with the system (e.g. by creating a service requestor profile). In some cases, the system may require registration of the user receiving the forward notification with the system (e.g. by creating a service requestor profile) before the system will allow the user to view the attributes and or geographical data associated with the service provision record.

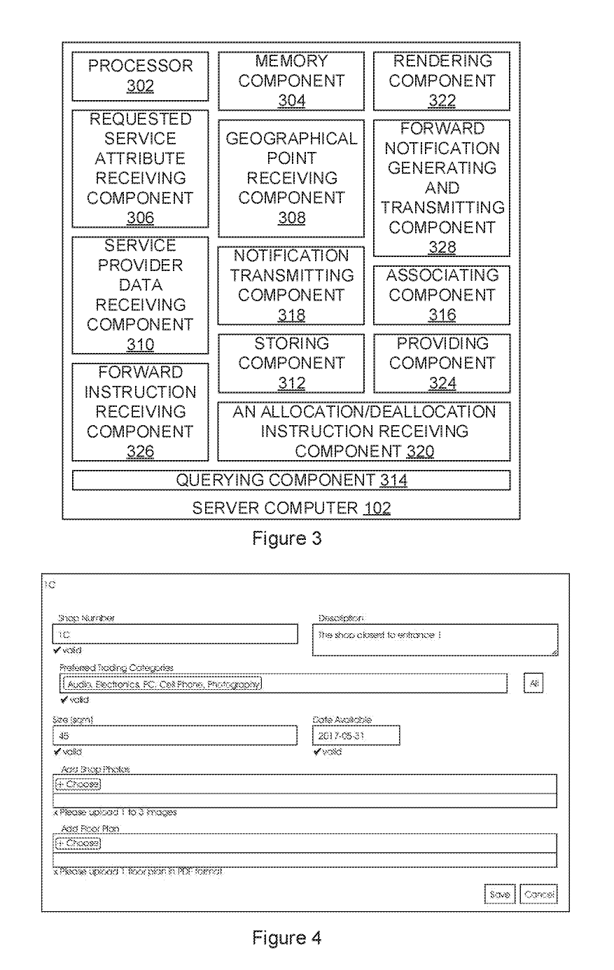

FIG. 3 is a block diagram which illustrates components of an exemplary system for matching a service provider to a service requestor. The system includes the server computer (102).

The server computer (102) may include a processor (302) for executing the functions of components described below, which may be provided by hardware or by software units executing on the server computer (102). The software units may be stored in a memory component (304) and instructions may be provided to the processor (302) to carry out the functionality of the described components.

The server computer (102) may include a requested service attribute receiving component (306) arranged to receive, from the service requestor via the service requestor portal (128), a set of attributes relating to a requested service.

The server computer (102) may include a geographical point receiving component (308) arranged to receive, from the service requestor via the service requestor portal (128), a plurality of points corresponding to geographical coordinates. The points may define a geographical polygon in which the requested service is to be provided.

The server computer (102) may include a service provider data receiving component (310) arranged to receive, from the service provider via the service provider portal (124), the geographical location data and attributes.

The server computer may include a storing component (312) arranged to store the attributes and points in association with a requested service record.

The server computer (102) may include a querying component (314) arranged to use the attributes and points to query a service provider database (116) to identify a service provision record being associated with attributes which substantially correspond to the attributes associated with the requested service record and being associated with geographical location data corresponding with the geographical polygon defined by the points.

The querying component (314) may be arranged to continually query the service provider database (116) on a periodic basis so as to identify any new service provision records having matching attributes and geographical location data. In some implementations, the querying component (314) may be configured to use the attributes and the geographical location data associated with the service provision record to query a service requestor database to identify requested service records being associated with attributes which substantially correspond to those of the service provision record and points which define a geographical location corresponding with the geographical location data.

The server computer (102) may include an associating component (316) arranged to associate an identified service provision record with the requested service record. The associating component (316) may also be arranged to associate received geographical location data and attributes with a service provision record.

The server computer (102) may include a notification transmitting component (318) arranged to transmit a notification of the association to one or both of the service provider and service requestor. The notification may be configured to be anonymous, including withholding the identities of the service provider and service requestor respectively.

The server computer (102) may include an allocation/deallocation instruction receiving component (320) arranged to receive allocation/deallocation instructions from the service provider via the service provider portal (124).

The server computer (102) may include a rendering component (322) arranged to render property overlays to indicate an allocation/deallocation status based on the allocation/deallocation instructions received.

The server computer (102) may include a providing component (324) arranged to provide, to one or both of the service provider and service requestor via the respective portals (124, 128), the rendered property overlays indicating the allocation/deallocation status for display on a map provided by the mapping service.

The server computer (102) may include a forward instruction receiving component (326) arranged to receive, from the service requestor via the service requestor portal (128), a forward instruction requesting forwarding of a notification of association of a service provision record with a requested service record.

The server computer (102) may include a forward notification generating and transmitting component (328) arranged to generate and transmit a forward notification to an identified communication address.

The described system and method accordingly provide a tool for matching of service providers to service requestors in a manner that caters with a high degree of specificity to the needs of the service providers and service requestors respectively. The tool may include a polygonal search function which permits highly specific geographical location selection. The tool may provide a floorplan overlay with interactive allocation/deallocation of available floor space from a lessee and/or lessor perspective. The tool may enable anonymous enquiries and a high degree of specificity regarding requirements/availability. The signing on of future users may be encouraged through functionality which, e.g., emails results to non-subscribed users and requires subscription to the system in order to see the results. The tool may further enable the forwarding of hits with or without search criteria as well as the cloning of search criteria and geographical polygon (e.g. to forwarding the search criteria (including geographical polygon) as is to alternative/new users).

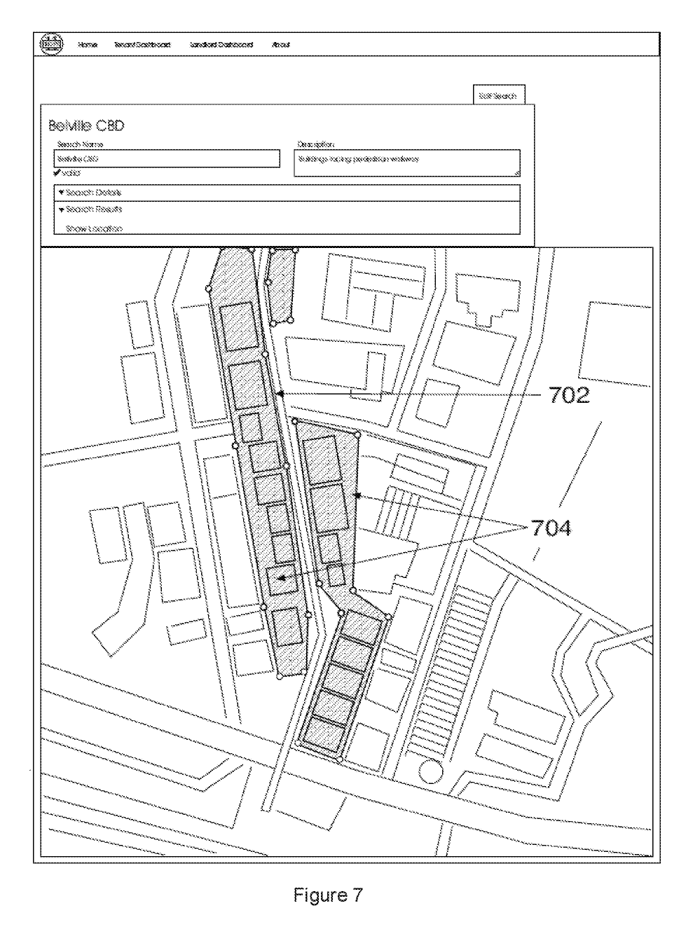

One exemplary in-use scenario of the described system and method is described with reference to FIG. 7. FIG. 7 illustrates an exemplary service requestor portal by way of which geographical points defining a number of geographical polygons are input and transmitted to a matching entity. In this exemplary scenario, the service requestor is a retailer looking for property. Due to the nature of the goods which the retailer sells, the retailer desires a high volume of pedestrian traffic to travel past the prospective property. The retailer is aware of a particular street (702) which is known to have a high volume of pedestrian traffic and would like to lease property adjacent this street (702). The retailer accordingly registers with the described system and method and uses the service requestor portal to input attributes of the desired property and a plurality of points corresponding to geographical coordinates and which define a number of geographical polygons (704). The retailer crafts the polygons such that they encompass only properties which are adjacent the particular street (702), as any other locations are not of interest to the retailer. Once the retailer is satisfied with the geographical polygons and attributes, the retailer saves the search (causing the requested service record to be created). At some stage (ranging from hours to days to weeks to months or even years), a property falling within one of the geographical polygons may become available (e.g. upon creation of a service provision record or an allocation input associated with an existing service provision record) and the retailer may be notified accordingly. Up until a match is identified, the fact that the retailer is seeking a property along the street (702) may remain completely confidential. Similarly, only if the attributes selected by the retailer (in particular retail property category, etc.) match those listed by the landlord will the retailer be alerted of the match. Otherwise, the retailer will remain oblivious to the fact that a property is available within one of the geographical polygons (albeit for another retail property category of goods).

The above example may be extended to a scenario in which the retailer seeks a property within a shopping centre (e.g. as illustrated in FIG. 6). The retailer may use the service requestor portal to define a number of geographical polygons. The polygons may be defined over floorplan polygons rendered on the map being displayed to the retailer via the service requestor portal. The retailer may be able to select different floor levels and may accordingly select very specific locations within a particular shopping centre at which the retailer would like to lease property (e.g. as illustrated in FIG. 6).

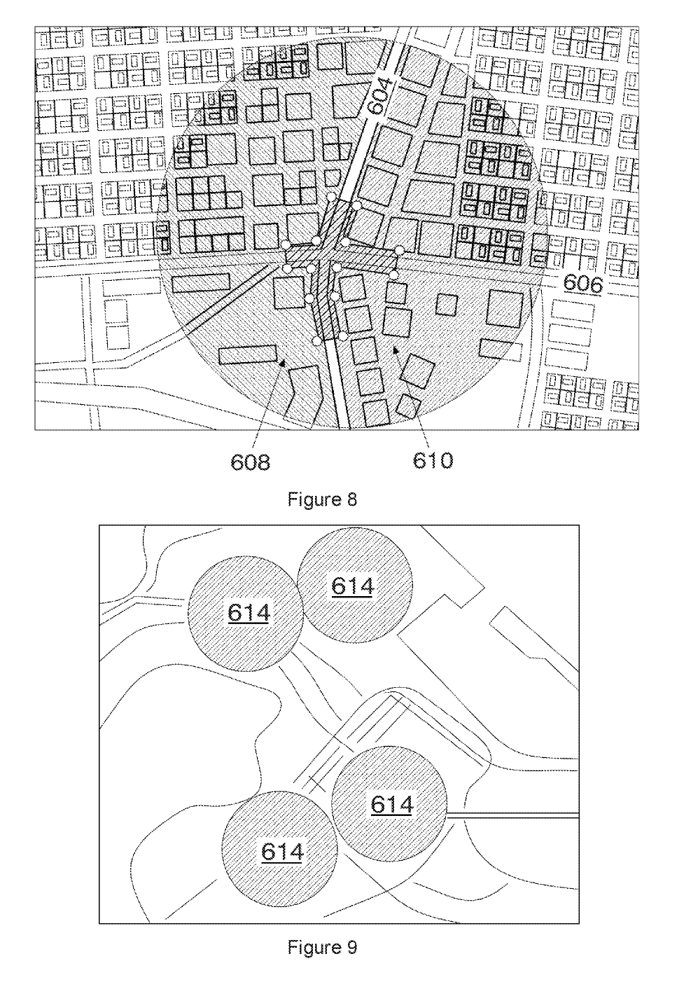

In some cases, for example as illustrated in FIG. 8, the service requestor may be interested in a small geographical area which spans multiple streets (604, 606) and/or suburbs (608, 610), e.g. more than one street and/or more than one suburb.

In some implementations, the service requestor portal may be configured to receive a negative search input corresponding to geographical locations which should specifically be excluded. For example, in some cases, a service requestor may input geographical radii which delineate deallocation of any new sites within an existing trade restriction area. For example, a particular franchisor may prescribe a radius associated with each franchise location from which further franchise locations are prohibited and a service requestor may use the service requestor portal to input such trade restriction areas for association with a particular requested service record. The negative search input may be stored in association with the requested service record and may be used by the server computer to identify appropriate service provision records. FIG. 9 illustrates exemplary geographical radii (614) which delineate deallocation of any new sites within an existing trade restriction area.

The described system and method further enable a service provider, being a lessor, to alert only retailers associated with a particular retail property category (e.g. jewelry) of an available property (subject to the association of a requested record with a service provision record as described above). By limiting the number of retail property categories the service requestor can select, fishing expeditions which expose the service provider's available properties may be prevented.

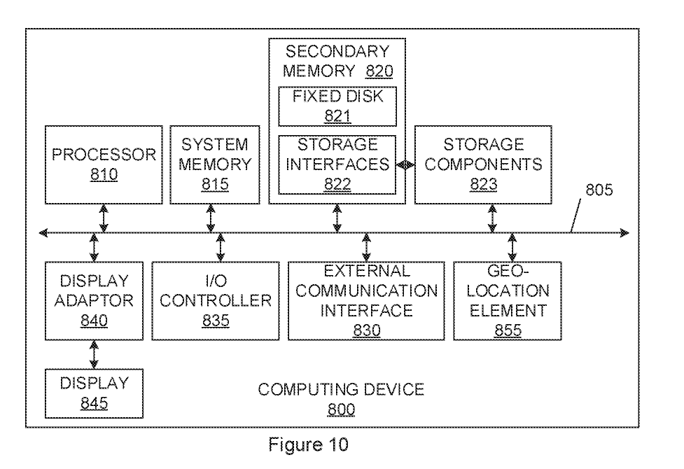

FIG. 10 illustrates an example of a computing device (800) in which various aspects of the disclosure may be implemented. The computing device (800) may be embodied as any form of data processing device including a personal computing device (e.g. laptop or desktop computer), a server computer (which may be self-contained, physically distributed over a number of locations), a client computer, or a communication device, such as a mobile phone (e.g. cellular telephone), satellite phone, tablet computer, personal digital assistant or the like. Different embodiments of the computing device may dictate the inclusion or exclusion of various components or subsystems described below.

The computing device (800) may be suitable for storing and executing computer program code. The various participants and elements in the previously described system diagrams may use any suitable number of subsystems or components of the computing device (800) to facilitate the functions described herein. The computing device (800) may include subsystems or components interconnected via a communication infrastructure (805) (for example, a communications bus, a network, etc.). The computing device (800) may include one or more processors (810) and at least one memory component in the form of computer-readable media. The one or more processors (810) may include one or more of: CPUs, graphical processing units (GPUs), microprocessors, field programmable gate arrays (FPGAs), application specific integrated circuits (ASICs) and the like. In some configurations, a number of processors may be provided and may be arranged to carry out calculations simultaneously. In some implementations various subsystems or components of the computing device (800) may be distributed over a number of physical locations (e.g. in a distributed, cluster or cloud-based computing configuration) and appropriate software units may be arranged to manage and/or process data on behalf of remote devices.

The memory components may include system memory (815), which may include read only memory (ROM) and random access memory (RAM). A basic input/output system (BIOS) may be stored in ROM. System software may be stored in the system memory (815) including operating system software. The memory components may also include secondary memory (820). The secondary memory (820) may include a fixed disk (821), such as a hard disk drive, and, optionally, one or more storage interfaces (822) for interfacing with storage components (823), such as removable storage components (e.g. magnetic tape, optical disk, flash memory drive, external hard drive, removable memory chip, etc.), network attached storage components (e.g. NAS drives), remote storage components (e.g. cloud-based storage) or the like.

The computing device (800) may include an external communications interface (830) for operation of the computing device (800) in a networked environment enabling transfer of data between multiple computing devices (800) and/or the Internet. Data transferred via the external communications interface (830) may be in the form of signals, which may be electronic, electromagnetic, optical, radio, or other types of signal. The external communications interface (830) may enable communication of data between the computing device (800) and other computing devices including servers and external storage facilities. Web services may be accessible by and/or from the computing device (800) via the external communications interface (830).

The external communications interface (830) may be configured for connection to wireless communication channels (e.g., a cellular telephone network, wireless local area network (e.g. using Wi-Fi™), satellite-phone network, Satellite Internet Network, etc.) and may include an associated wireless transfer element, such as an antenna and associated circuity. The external communications interface (830) may include a subscriber identity module (SIM) in the form of an integrated circuit that stores an international mobile subscriber identity and the related key used to identify and authenticate a subscriber using the computing device (800). One or more subscriber identity modules may be removable from or embedded in the computing device (800).

The computer-readable media in the form of the various memory components may provide storage of computer-executable instructions, data structures, program modules, software units and other data. A computer program product may be provided by a computer-readable medium having stored computer-readable program code executable by the central processor (810). A computer program product may be provided by a non-transient computer-readable medium, or may be provided via a signal or other transient means via the communications interface (830).

Interconnection via the communication infrastructure (805) allows the one or more processors (810) to communicate with each subsystem or component and to control the execution of instructions from the memory components, as well as the exchange of information between subsystems or components. Peripherals (such as printers, scanners, cameras, or the like) and input/output (I/O) devices (such as a mouse, touchpad, keyboard, microphone, touch-sensitive display, input buttons, speakers and the like) may couple to or be integrally formed with the computing device (800) either directly or via an I/O controller (835). One or more displays (845) (which may be touch-sensitive displays) may be coupled to or integrally formed with the computing device (800) via a display (845) or video adapter (840).

The computing device (800) may include a geographical location element (855) which is arranged to determine the geographical location of the computing device (800). The geographical location element (855) may for example be implemented by way of a global positioning system (GPS) or similar receiver module. In some implementations the geographical location element (855) may implement an indoor positioning system, using, for example, communication channels such as cellular telephone or Wi-Fi™ networks and/or beacons (e.g. Bluetooth™ Low Energy (BLE) beacons, iBeacons™, etc.) to determine or approximate the geographical location of the computing device (800). In some implementations, the geographical location element (855) may implement inertial navigation to track and determine the geographical location of the communication device using an initial set point and inertial measurement data.

The foregoing description has been presented for the purpose of illustration; it is not intended to be exhaustive or to limit the invention to the precise forms disclosed. Persons skilled in the relevant art can appreciate that many modifications and variations are possible in light of the above disclosure.

Any of the steps, operations, components or processes described herein may be performed or implemented with one or more hardware or software units, alone or in combination with other devices. In one embodiment, a software unit is implemented with a computer program product comprising a non-transient computer-readable medium containing computer program code, which can be executed by a processor for performing any or all of the steps, operations, or processes described. Software units or functions described in this application may be implemented as computer program code using any suitable computer language such as, for example, Java™, C++, or Perl™ using, for example, conventional or object-oriented techniques. The computer program code may be stored as a series of instructions, or commands on a non-transitory computer-readable medium, such as a random access memory (RAM), a read-only memory (ROM), a magnetic medium such as a hard-drive, or an optical medium such as a CD-ROM. Any such computer-readable medium may also reside on or within a single computational apparatus, and may be present on or within different computational apparatuses within a system or network.

Flowchart illustrations and block diagrams of methods, systems, and computer program products according to embodiments are used herein. Each block of the flowchart illustrations and/or block diagrams, and combinations of blocks in the flowchart illustrations and/or block diagrams, may provide functions which may be implemented by computer readable program instructions. In some alternative implementations, the functions identified by the blocks may take place in a different order to that shown in the flowchart illustrations.

The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

Finally, throughout the specification unless the contents requires otherwise the word ‘comprise’ or variations such as ‘comprises’ or ‘comprising’ will be understood to imply the inclusion of a stated integer or group of integers but not the exclusion of any other integer or group of integers.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

We claim:

1. A computer-implemented method for matching a service provider to a service requestor comprising:
receiving, from a service requestor via a service requestor portal, a set of attributes relating to a requested service;
receiving, from the service requestor via the service requestor portal, a plurality of points corresponding to geographical coordinates, the points defining a geographical polygon in which the requested service is to be provided;
storing the attributes and points in association with a requested service record;
using the attributes and points to query a service provider database to identify a service provision record being associated with attributes which substantially correspond to the attributes associated with the requested service record and being associated with geographical location data corresponding with the geographical polygon defined by the points;
associating an identified service provision record with the requested service record; and,
transmitting a notification of the association to one or both of the service provider and service requestor.

2. The method as claimed in claim 1, including: receiving, from the service provider via a service provider portal, the geographical location data and attributes; and, associating the received geographical location data and attributes with the service provision record.

3. The method as claimed in claim 1, including continually querying the service provider database on a periodic basis so as to identify any new service provision records having matching attributes and geographical location data.

4. The method as claimed in claim 1, including using the attributes and the geographical location data associated with the service provision record to query a service requestor database to identify requested service records being associated with attributes which substantially correspond to those of the service provision record and points which define a geographical location with which the geographical location data corresponds.

5. The method as claimed in claim 1, wherein the identity of the service provider is withheld from the service requestor until association of the identified service provision record with the requested service record and wherein the identity of the service requestor is withheld from the service provider until the service requestor initiates contact with the service provider in response to the association of the identified service provision record with the requested service record.

6. The method as claimed in claim 1, including:
receiving allocation/deallocation instructions from the service provider via the service provider portal;
rendering property overlays to indicate an allocation/deallocation status based on the allocation/deallocation instructions received; and
providing, to one or both of the service provider and service requestor via the service provider and service requestor portals respectively, the rendered property overlays indicating the allocation/deallocation status for display on a map provided by a mapping service.

7. The method as claimed in claim 1, including:
receiving, from the service requestor via the service requestor portal, a forward instruction requesting forwarding of a notification of association of a service provision record with a requested service record; and,
generating and transmitting a forward notification to an identified communication address.

8. A system for matching a service provider to a service requestor, the system including a memory for storing computer-readable program code and a processor for executing the computer-readable program code, the system comprising:
a requested service attribute receiving component for receiving, from a service requestor via a service requestor portal, a set of attributes relating to a requested service;
a geographical point receiving component for receiving, from the service requestor via the service requestor portal, a plurality of points corresponding to geographical coordinates, the points defining a geographical polygon in which the requested service is to be provided;
a storing component for storing the attributes and points in association with a requested service record;
a querying component for using the attributes and points to query a service provider database to identify a service provision record being associated with attributes which substantially correspond to the attributes associated with the requested service record and being associated with geographical location data corresponding to the geographical polygon defined by the points;
an associating component for associating an identified service provision record with the requested service record; and,
a notification transmitting component for transmitting a notification of the association to one or both of the service provider and service requestor.

9. The system as claimed in claim 8, including a service provider data receiving component for receiving, from the service provider via a service provider portal, the geographical location data and attributes, and wherein the associating component associates the received geographical location data and attributes with the service provision record.

10. The system as claimed in claim 8, wherein the querying component continually queries the service provider database on a periodic basis so as to identify any new service provision records having corresponding attributes and geographical location data.

11. The system as claimed in claim 8, wherein the querying component uses the attributes and the geographical location data associated with the service provision record to query a service requestor database to identify requested service records being associated with attributes which substantially correspond to those of the service provision record and points which define a geographical location with which the geographical location data corresponds.

12. The system as claimed in claim 8, wherein the identity of the service provider is withheld from the service requestor until association of the identified service provision record with the requested service record and wherein the identity of the service requestor is withheld from the service provider until the service requestor initiates contact with the service provider in response to the association of the identified service provision record with the requested service record.

13. The system as claimed in claim 8, including:
an allocation/deallocation instruction receiving component for receiving allocation/deallocation instructions from the service provider via the service provider portal;
a rendering component for rendering property overlays to indicate an allocation/deallocation status based on the allocation/deallocation instructions received; and,
a providing component for providing, to one or both of the service provider and service requestor via the service provider and service requestor portals respectively, the rendered property overlays indicating the allocation/deallocation status for display on a map provided by a mapping service.

14. The system as claimed in claim 8, including:
a forward instruction receiving component for receiving, from a service requestor via a service requestor portal, a forward instruction requesting forwarding of a notification of association of a service provision record with a requested service record; and,
a forward notification generating and transmitting component generating and transmitting a forward notification to an identified communication address.

15. A computer program product for matching a service provider to a service requestor, the computer program product comprising a computer-readable medium having stored computer-readable program code for performing the steps of:
receiving, from a service requestor via a service requestor portal, a set of attributes relating to a requested service;
receiving, from the service requestor via the service requestor portal, a plurality of points corresponding to geographical coordinates, the points defining a geographical polygon in which the requested service is to be provided;
storing the attributes and points in association with a requested service record;
using the attributes and points to query a service provider database to identify a service provision record being associated with attributes which substantially correspond to the attributes associated with the requested service record and being associated with geographical location data corresponding with the geographical polygon defined by the points;
associating an identified service provision record with the requested service record; and,
transmitting a notification of the association to one or both of the service provider and service requestor.
